(19) United States
(12) Patent Application Publication
(10) Pub. No.: US 2015/0029470 A1
(43) Pub. Date: Jan. 29, 2015

(54) IMAGE PROJECTION APPARATUS AND METHOD FOR CONTROLLING IMAGE PROJECTION APPARATUS

(71) Applicants: Hideo KANAI, Tokyo (JP); Tetsuya FUJIOKA, Kanagawa (JP); Akihisa MIKAWA, Kanagawa (JP); Naoyuki ISHIKAWA, Kanagawa (JP); Masamichi YAMADA, Kanagawa (JP); Yasunari MIKUTSU, Tokyo (JP); Satoshi TSUCHIYA, Kanagawa (JP)

(72) Inventors: Hideo KANAI, Tokyo (JP); Tetsuya FUJIOKA, Kanagawa (JP); Akihisa MIKAWA, Kanagawa (JP); Naoyuki ISHIKAWA, Kanagawa (JP); Masamichi YAMADA, Kanagawa (JP); Yasunari MIKUTSU, Tokyo (JP); Satoshi TSUCHIYA, Kanagawa (JP)

(21) Appl. No.: 14/331,391

(22) Filed: Jul. 15, 2014

(30) Foreign Application Priority Data
Jul. 24, 2013 (JP) 2013-153861

(51) Int. Cl. G03B 21/16

(52) U.S. Cl. CPC G03B 21/16
USPC 353/57; 353/52; 353/121

(57) ABSTRACT

An image projection apparatus according to the present invention, includes: an air-intake port that takes in outside air for cooling the inside of a housing; a heater that is provided near the air-intake port and generates heat with supply of electric power; a temperature sensor that is provided next to the heater; and a controller that monitors a decrease in the flow velocity of outside air taken in through the air-intake port based on temperature values measured by the temperature sensor.

### CROSS-REFERENCE TO RELATED APPLICATION(S)

The present application claims priority to and incorporates by reference the entire contents of Japanese Patent Application No. 2013-153861 filed in Japan on Jul. 24, 2013.

### BACKGROUND OF THE INVENTION

1. Field of the Invention

The present invention relates to an image projection apparatus and a method for controlling the image projection apparatus.

2. Description of the Related Art

Image projection apparatuses have been known that display images by modulating light beams emitted from light sources based on image data from personal computers, video cameras, or other devices and projecting the modulated light beams onto screens or the like.

Halogen lamps, metal halide lamps, high pressure mercury lamps, or other lamps are used for the light sources of such image projection apparatuses. These light sources can reach a high temperature of a maximum of around 1000° C. For this reason, in the image projection apparatuses, blowing units such as blowers and fans take in air from the outside and blow the air to the light sources to cool them.

When air used for cooling contains dust, the dust may adhere to the optical components and the optical path area of the light source inside an image projection apparatus. The dust adhering to the optical components and the optical path area of the light source may cut off light beams for projecting images onto a screen, thereby reducing brightness of the projection images and degrading image quality. Upon this, a dust filter is typically provided at an air-intake port from which air is taken inside an image projection apparatus.

However, such a dust filter may be clogged up during the process of removing dust from the air with the dust filter, leading to a situation where it is difficult to take in air from the outside of the image projection apparatus. The reliability and the service life of image projection apparatuses are secured by taking in air from the outside of the housings and cooling the optical components, the light source, and the electric circuits of the apparatuses. Thus, the reliability and the service life originally possessed by the apparatuses cannot be secured under circumstances where their dust filters are clogged up.

For example, a method has been known that detects clogging up of a dust filter by measuring the temperature difference between the inside and the outside of an image projection apparatus (see Japanese Laid-open Patent Publication No. 2012-032583). In the measurement of the temperature difference between the inside and the outside of an image projection apparatus, it is necessary to measure the temperature at at least two points. This may cause false detection arising from doubled error of reading with temperature sensors and may increase the number of components such as temperature sensors and wire harnesses, disadvantageously.

In view of above-mentioned problems of the conventional art, there is a need to provide an image projection apparatus and a method for controlling an image projection apparatus that are capable of monitoring a decrease in ability to take in outside air by measuring the temperature at a single measurement point.

### SUMMARY OF THE INVENTION

It is an object of the present invention to at least partially solve the problems in the conventional technology.

According to the present invention, there is provided an image projection apparatus comprising: an air-intake port that is provided at a housing and is configured to take in outside air for cooling inside of the housing; a heat generating unit that is provided near the air-intake port and generates heat with supply of electric power; a temperature detecting unit that is provided next to the heat generating unit; and a controlling unit that monitors a decrease in a flow velocity of outside air taken in through the air-intake port based on a temperature value measured by the temperature detecting unit.

The present invention also provides a method for controlling an image projection apparatus that includes an air-intake port that is provided at a housing and is configured to take in outside air for cooling inside of the housing, a heat generating unit that is provided near the air-intake port and generates heat with supply of electric power, and a temperature detecting unit that is provided next to the heat generating unit, the method comprising: monitoring a decrease in a flow velocity of outside air taken in through the air-intake port based on a temperature value measured by the temperature detecting unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a projector according to an embodiment of the present invention;

FIG. 2 is a schematic diagram of optical paths from a projector to a projection plane;

FIG. 3(a) is a perspective view of the projector from which an outer cover is removed;

FIG. 3(b) is a perspective view of the projector from which the outer cover removed;

FIG. 4 is a perspective view of an optical engine unit and a light source unit of the projector;

FIG. 5 is a perspective view of the optical engine unit of the projector;

FIG. 6 is a diagram illustrating optical paths in a lighting unit of the projector;

FIG. 7 is a perspective view of an image forming unit of the projector;

FIG. 8 is a perspective view of the optical engine unit from which a casing of a first optical unit and a second optical unit are removed;

FIG. 9 is a perspective view of the optical engine unit from which casings of the first optical unit and the second optical unit are removed;

FIG. 10 is a schematic of optical paths from a first optical system of the projector to a projection plane;

FIG. 11 is a perspective view of the projector for illustrating the configuration of an air-intake port;

FIG. 12 is a sectional view of the projector for illustrating air flow inside a housing of the projector;

FIG. 13 is a perspective view illustrating the configuration of the front surface of a temperature detecting device of the projector;

FIG. 14 is a perspective view illustrating the configuration of the back surface of the temperature detecting device; and

FIG. 15 is a block diagram of a main circuit unit that performs a protection operation for the projector.

### DETAILED DESCRIPTION OF THE PREFERRED EMBODIMENTS

The following describes an embodiment of a projector as an image projection apparatus to which the present invention is applied.

Image Projection Apparatus

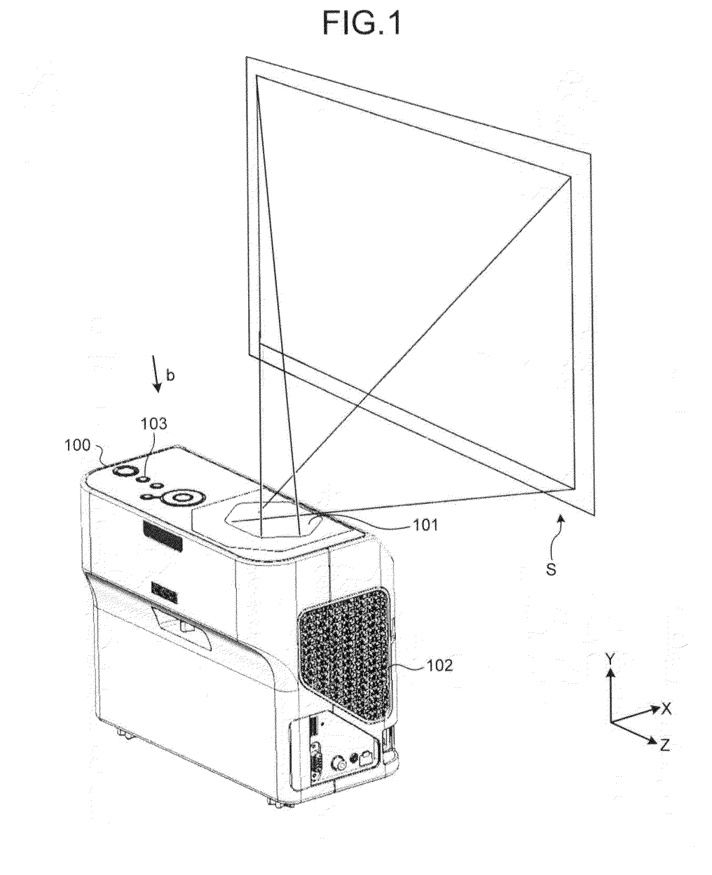

FIG. 1 is a perspective view illustrating a projector 100 according to an embodiment of the present invention. The projector 100 is an apparatus that projects images or video (hereinafter, simply called images or the like) onto a projection plane S based on image data or video data input from a personal computer, a video camera, or any other device. As illustrated in FIG. 1, a transparent glass 101 is provided at the upper surface of the projector 100, and light beams emitted through the transparent glass 101 show images or the like on the projection plane S. An air-intake port 102 is provided at the housing of the projector 100, and outside air is taken in through the air-intake port 102 to cool the inside of the housing of the projector 100.

There are various kinds of projectors such as a projector employing a liquid crystal panel and a projector employing a digital micro-mirror device (DMD). In recent projectors employing liquid crystals, the following matters have been progressed, for example: a further increase in the resolution of liquid crystal panels; improvement of brightness along with an increase in the efficiency of light source lamps, and price reduction. On the other hand, projectors employing a DMD are compact and lightweight and thus have been widely used in not only offices or schools but also at home.

In particular, front projectors with improved portability have been used also for small group meeting. There are also demands for projectors to allow images or the like to be projected onto a large screen (enlarge the screen size of a projected surface) as well as to allow a projection space needed at the outside of the projectors to be reduced as much as possible.

The projector 100 to be described hereinafter is a front projector employing a DMD, but the type of projectors applicable to the embodiment of the present invention is not limited to this. A projector employing a liquid crystal panel or other projectors are also properly applicable. In the following description, the direction of a normal to the projection plane S is designated as the X direction, the minor axis direction (vertical direction) of the projection plane S is designated as the Y direction, and the major axis direction (horizontal direction) of the projection plane S is designated as the Z direction.

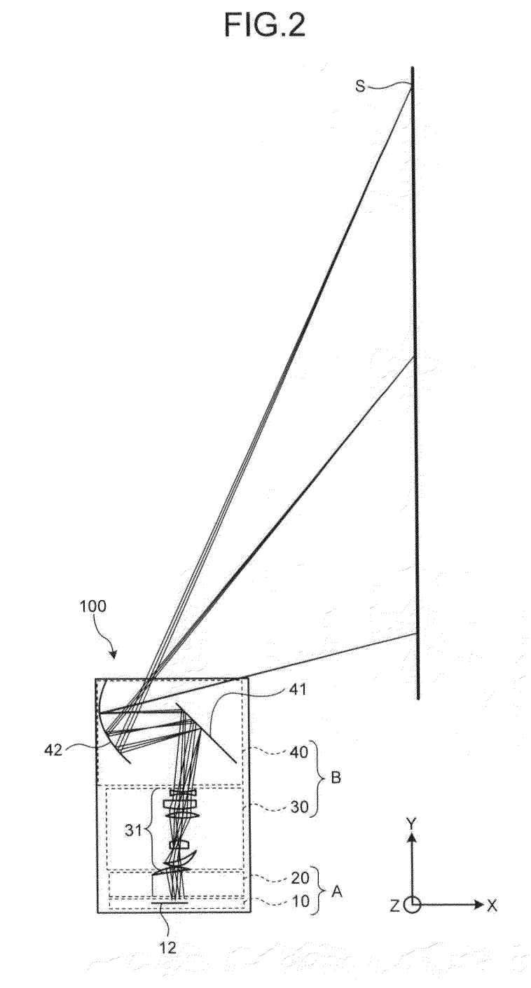

FIG. 2 is a schematic of optical paths from the projector 100 to the projection plane S. As illustrated in FIG. 2, the optical systems inside the housing of the projector 100 includes an image forming section A for forming images using light from a light source, and a projection optical system B for projecting the formed images onto the projection plane S.

The image forming section A includes an image forming unit 10 having a DMD 12 as an image forming element and a lighting unit 20 that reflects light from the light source to irradiate the DMD 12 with the light for light figure generation. The projection optical system B includes a first optical unit 30 having a first optical system 31 of a co-axial system with a positive power and a second optical unit 40 having a reflection mirror 41 and a free-curved mirror 42 with a positive power.

The DMD 12 is irradiated with light beams from the light source in the lighting unit 20 to be described in detail later and modulates the light beams to generate an image. The image generated by the DMD 12 passes through the first optical system 31 of the first optical unit 30 and via the reflection mirror 41 and the free-curved mirror 42 of the second optical unit 40 in this order and is projected onto the projection plane S.

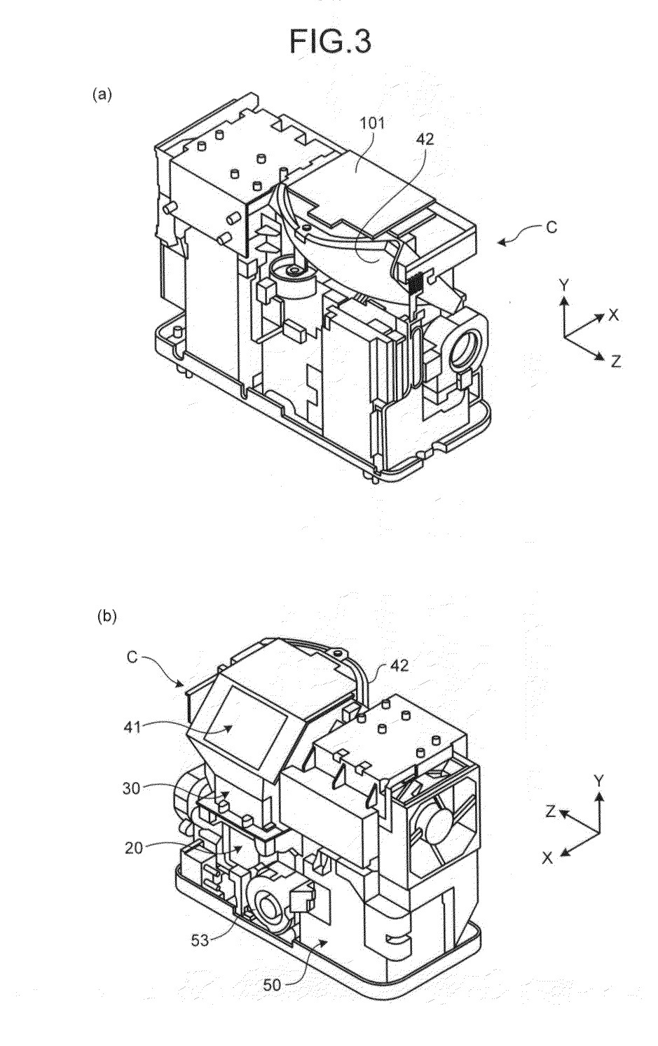

FIGS. 3(a) and 3(b) are perspective views in a state where the outer cover of the projector 100 is removed. FIG. 3(a) is a perspective view from the same point as FIG. 1 while FIG. 3(b) is a perspective view from a point of sight in a direction indicated by the arrow b in FIG. 1.

As illustrated in FIGS. 3(a) and 3(b), the projector 100 includes an optical engine unit C that contains therein vertically (in the Y direction in FIGS. 3(a) and 3(b)) the image forming section A and the projection optical system B. The optical engine unit C vertically contains therein the image forming unit 10 having the DMD 12 and the first optical system 31 of a co-axial system with a positive power, as illustrated in FIG. 2. The optical engine unit C further contains therein the reflection mirror 41 and the free-curved mirror 42 so that they may face to each other, as illustrated in FIG. 2. The reflection mirror 41 reflects the light beams emitted from the first optical system 31 in the vertical direction, and the free-curved mirror 42 condenses the light beams reflected by the reflection mirror 41 onto the projection plane S.

As described above, the DMD 12, the first optical system 31, the reflection mirror 41, and the free-curved mirror 42 are arranged inside the optical engine unit C. The projector 100 is thus compact, in which optical paths from the DMD 12 as an image forming section to the projection plane S are efficiently arranged.

The optical system of the projector 100 will be described separately a lighting optical system and a projection optical system.

Lighting Optical System

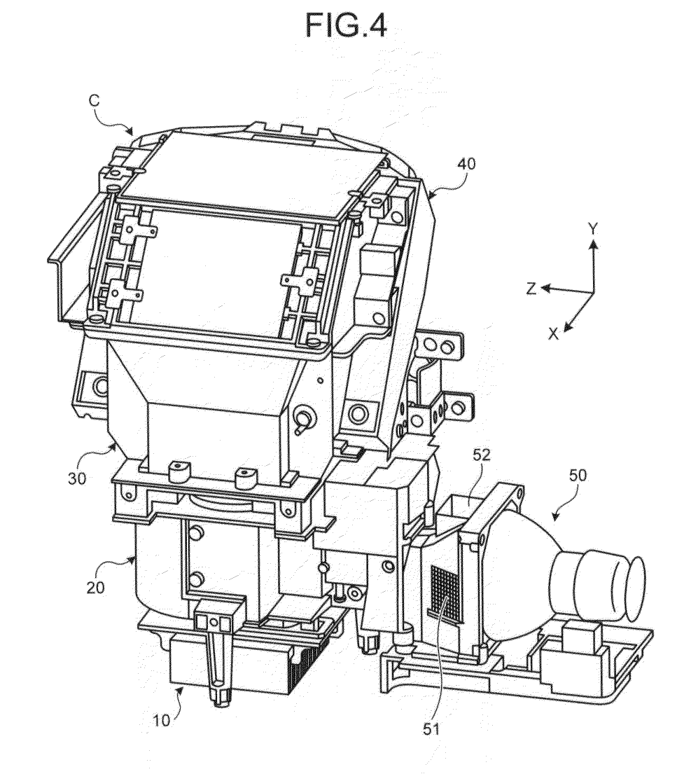

The lighting optical system is described with reference to FIGS. 4 to 7. FIG. 4 is a perspective view of the optical engine unit C and a light source unit 50. As illustrated in FIG. 4, the image forming unit 10, the lighting unit 20, the first optical unit 30, the second optical unit 40 are arranged along with the Y direction in FIG. 4. In contrast, the lighting unit 20 and the light source unit 50 are arranged side by side in the Z direction in FIG. 4. Specifically, the lighting optical system contained in the lighting unit 20 and the light source unit 50 is laterally (in the Z direction in FIG. 4) arranged near the bottom in the projector 100.

As will be described in detail later, the light source unit 50 includes therein the light source and emits illumination light to the lighting unit 20 of the optical engine unit C. A light-source air supply port 51 through which air enters into the light source unit 50 for cooling the light source is provided at the side face of the light source unit 50. A light-source air exhaust port 52 through which air heated by heat from the light source is exhausted from the light source unit 50 is provided at the upper surface of the light source unit 50.

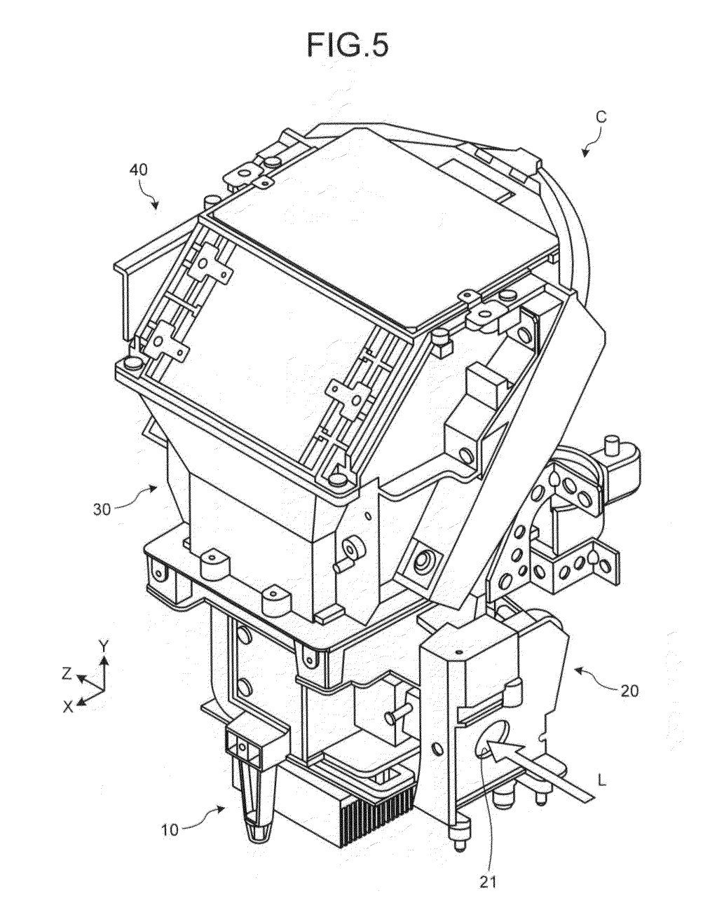

FIG. 5 is a perspective view of the optical engine unit C. As illustrated in FIG. 5, an entry port 21 for introducing an optical path L of illumination light emitted from the light source unit 50 is provided at the lighting unit 20 of the optical engine unit C.

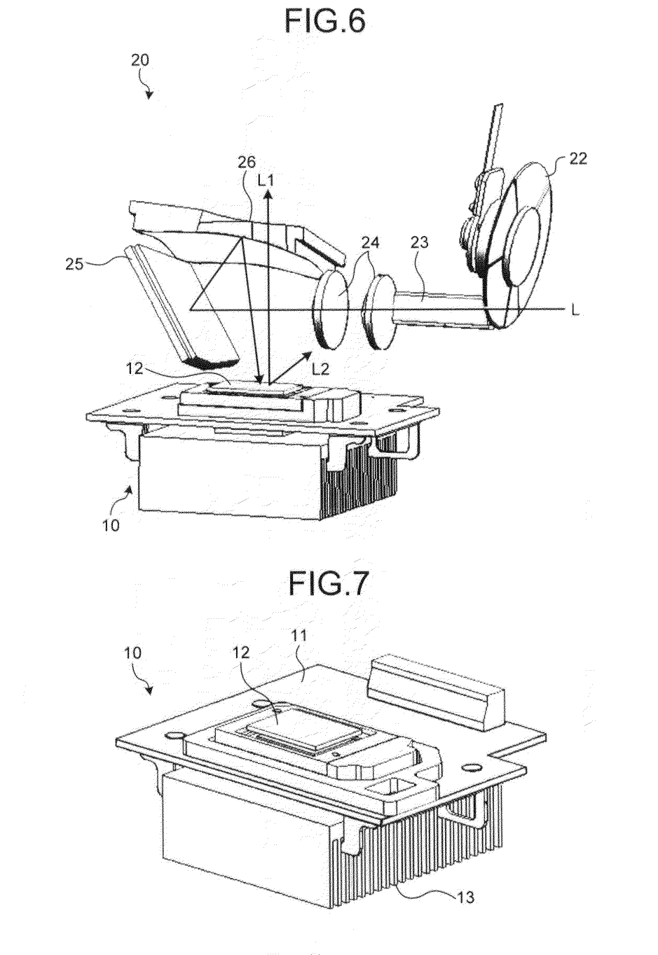

FIG. 6 is a diagram illustrating optical paths in the lighting unit 20. As illustrated in FIG. 6, the lighting unit 20 includes therein a color wheel 22, a light tunnel 23, relay lenses 24, a cylinder mirror 25, and a concave mirror 26. The optical path L of the illumination light emitted from the light source unit 50 passes through the color wheel 22, the light tunnel 23, and the relay lenses 24, and then via the cylinder mirror 25 and the concave mirror 26 in this order and reaches the DMD 12 of the image forming unit 10.

The color wheel 22 is a disc-shaped filter wheel fixed to a motor shaft. Filters for color separation of the illumination light into red (R), green (G), blue (B), or other colors are provided at the color wheel 22 in its rotation direction. The color wheel 22 rotates to time-resolve the illumination light passing through the color wheel 22 into light of R, G, or B.

The light subjected to color separation by the color wheel 22 enters the light tunnel 23. The inner surface of the light tunnel 23 is mirror finished. The light that has entered in the light tunnel 23 is reflected by the inner surface of the light tunnel 23 a plurality of times to be homogenized and is emitted to the relay lenses 24.

The light that has passed through the light tunnel 23 passes through two of the relay lenses 24 and is reflected by the cylinder mirror 25 and the concave mirror 26 to be condensed onto an image generating surface of the DMD 12.

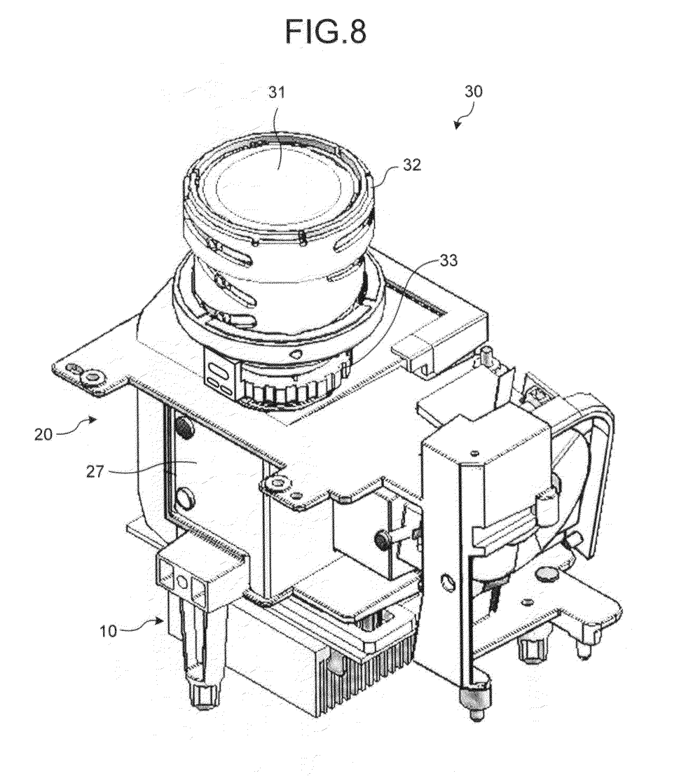

The DMD 12 is one component of the image forming unit 10 to be described in detail later. The DMD 12 reflects the radiated illumination light into an optical path L1 to the first optical system 31 and an optical path L2 to a light OFF plate 27 (illustrated in FIG. 8) while switching between the optical paths by inclining each micro-mirror element on the image generating surface. Such micro-mirror elements on the image generating surface are arrayed in a lattice pattern, and one micro-mirror element corresponds to one pixel in a projection image. Thus, the DMD 12 can convert the radiated illumination light into projection light having information of a projection image by controlling each of the micro-mirror elements.

FIG. 7 is a perspective view of the image forming unit 10. As illustrated in FIG. 7, the image forming unit 10 includes the DMD 12 and a heat sink 13 both of which are mounted to a DMD board 11. As illustrated in FIG. 7, the DMD 12 and the heat sink 13 are oppositely mounted to respective surfaces of the DMD board 11. A through hole is formed in a portion of the DMD board 11 where the DMD 12 is mounted, through which the back surface (the surface opposite to the image generating surface) of the DMD 12 comes into contact with the heat sink 13 with a heat conducting member interposed therebetween. With this configuration, heat generated from the DMD 12 is conducted to the heat sink 13, and when the heat sink 13 is cooled, the DMD 12 also undergoes cooling action.

Projection Optical System

The projection optical system is described with reference to FIGS. 8 to 10. FIG. 8 is a perspective view of the optical engine unit C from which the casing of the first optical unit 30 and the second optical unit 40 are removed. As illustrated in FIG. 8, the first optical unit 30 is arranged above the lighting unit 20 and includes a projection lens unit 32 that holds the first optical system 31 having a plurality of lenses.

The projection lens unit 32 includes a focus gear 33. The focus of the first optical system 31 in the projection lens unit 32 can be adjusted by turning the focus gear 33.

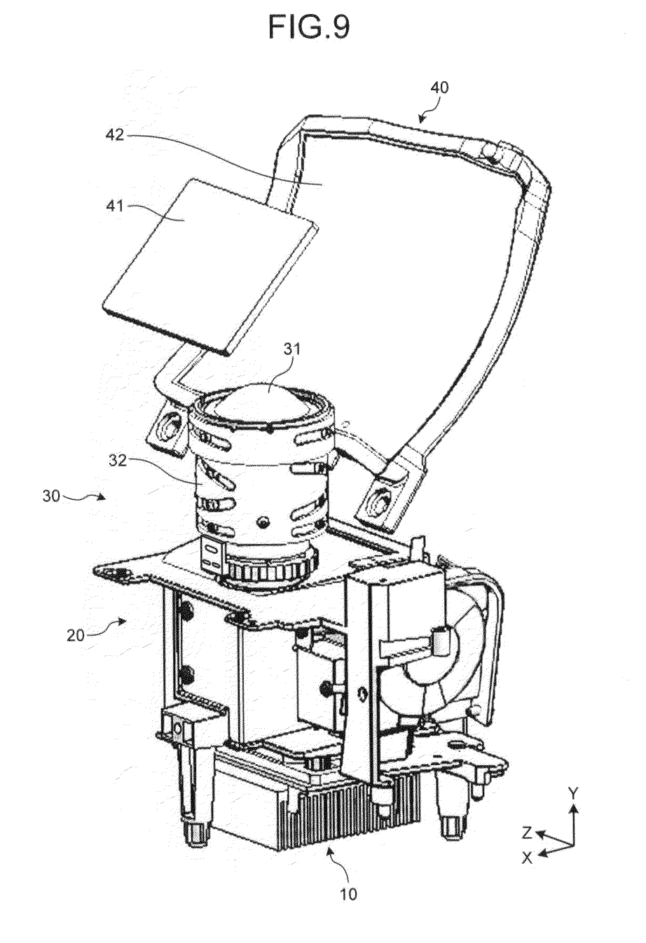

FIG. 9 is a perspective view of the optical engine unit C from which the casings of the first optical unit 30 and the second optical unit 40 are removed. As illustrated in FIG. 9, the second optical unit 40 includes the reflection mirror 41 and the free-curved mirror 42 having a concaved surface, constituting a second optical system. The reflection mirror 41 is arranged above the emitting port of the projection lens unit 32 (in the Y direction in FIG. 9) and reflects the light beams emitted from the first optical system 31 in the projection lens unit 32 toward the free-curved mirror 42. The free-curved mirror 42 is arranged so as to face to the reflection surface of the reflection mirror 41 almost parallelly and reflects the light beams reflected by the reflection mirror 41 to the outside of the projector 100.

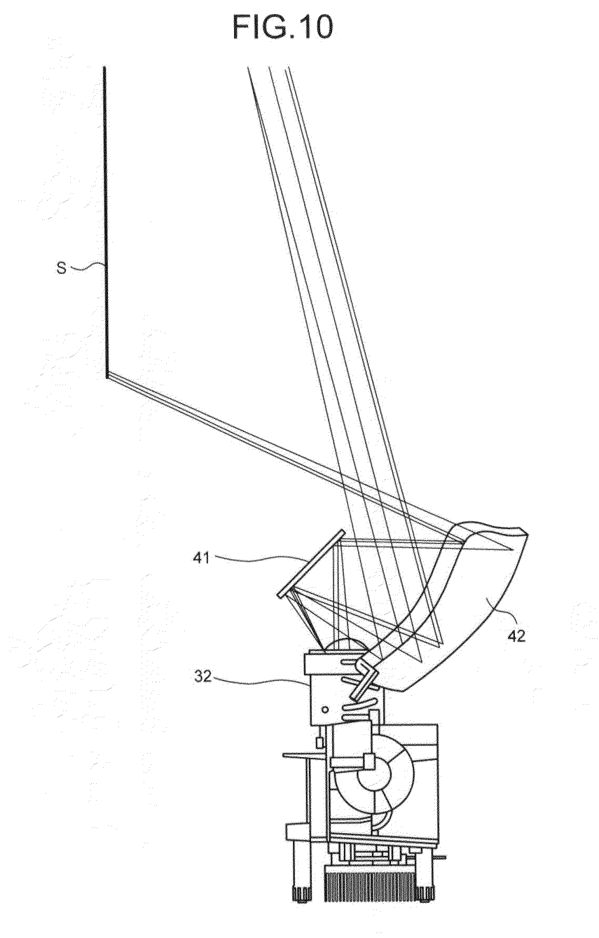

FIG. 10 is a schematic diagram of optical paths from the first optical system 31 to the projection plane S. The light beams emitted from the first optical system 31 in the projection lens unit 32 form an intermediate image between the reflection mirror 41 and the free-curved mirror 42. The free-curved mirror 42 enlarges this intermediate image and projects the enlarged image onto the projection plane S to form an image.

As described above, the projector 100 enables reduction in projection distance by forming an intermediate image between the reflection mirror 41 and the free-curved mirror 42 and enlarging the intermediate image with the free-curved mirror 42. Thus, the projector 100 can be used even in a small meeting room or the like.

Air Cooling System

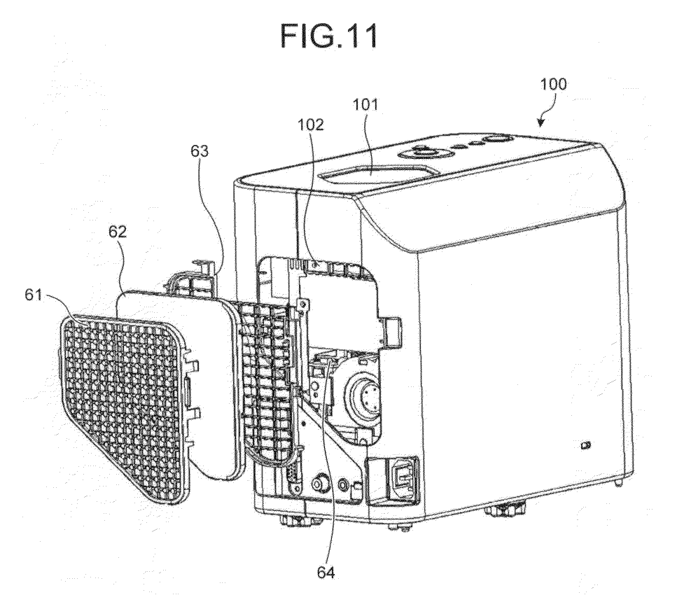

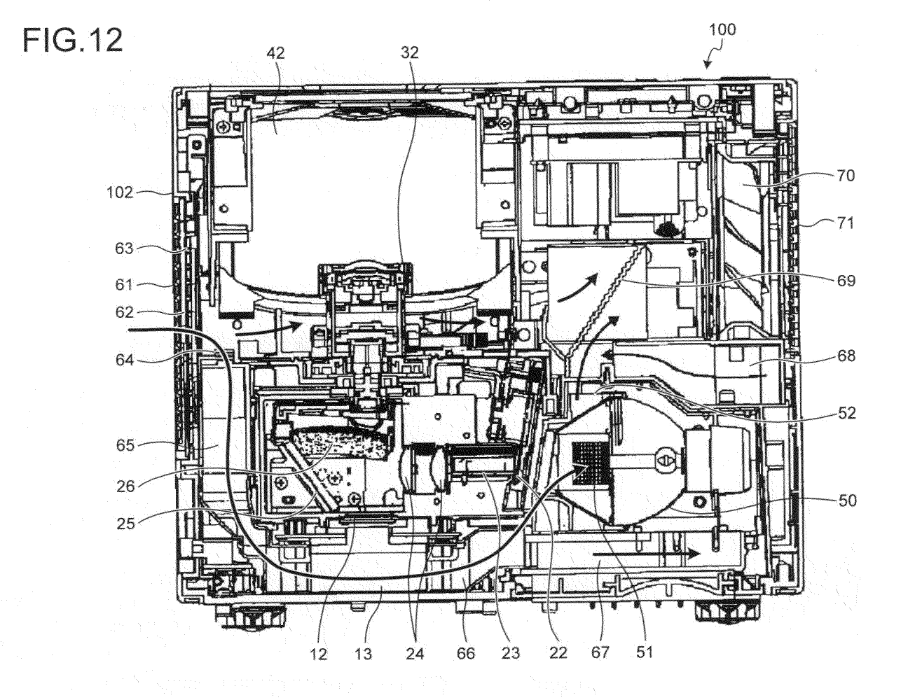

The air cooling system of the projector 100 is described with reference to FIGS. 11 and 12.

FIG. 11 is a perspective view of the projector 100 illustrating the configuration of the air-intake port 102. As illustrated in FIG. 11, the air-intake port 102 of the projector 100 is configured by inserting an air-intake port cover 61, a dust filter 62, and an air-intake grid 63 into an opening formed in the outer cover of the projector 100. Air outside the projector 100 passes through the air-intake port cover 61, the dust filter 62, and the air-intake grid 63 in this order and is taken into the projector 100 after dust and dirt are removed therefrom.

A temperature detecting device 64 to be described in detail later with reference to FIGS. 12 to 14 is provided near the air-intake port 102 in the projector 100. However, the installation position of the temperature detecting device 64 is not limited to the position illustrated in FIG. 12. The embodiment of the present invention can be performed properly so long as the installation position is a position toward which air that has been introduced from the outside of the projector 100 through the air-intake port 102 properly flows.

FIG. 12 is a sectional view of the projector 100 for illustrating air flow inside the housing of the projector 100. As illustrated in FIG. 12, the outside air introduced from the air-intake port 102 is separated into a flow passage through which the air moves in a straight line in the projector 100 and a flow passage through which the air is led to the lower part of the projector 100.

The flow passage through which the air moves in a straight line in the projector 100 is a flow passage for cooling mainly the entire projector 100, electronic circuits, and the like. The flow passage through which the air is led to the lower part of the projector 100 is a flow passage for cooling large heat-producing sources such as the DMD 12 and the light source unit 50. The following describes the flow passage through which the air is led to the lower part of the projector 100 that is a flow passage for cooling the large heat-producing sources.

The outside air introduced from the air-intake port 102 is led into a vertical duct 65. The outside air led to the lower part of the projector 100 through the vertical duct 65 is guided toward the light source unit 50 through a horizontal duct 66.

The aforementioned heat sink 13 for cooling the DMD 12 is exposed in the horizontal duct 66, and the outside air introduced from the outside of the projector 100 cools the heat sink 13, thereby cooling the DMD 12.

The outside air that flows inside the horizontal duct 66 cools the heat sink 13 and then is used for cooling the light source unit 50. The air flowing inside the horizontal duct 66 is introduced into the light-source air supply port 51 through a light source blower 53 (illustrated in FIG. 3(b)). The air introduced from the light-source air supply port 51 cools the light source unit 50 from its inside. The air in the light source unit 50 is exhausted through the light-source air exhaust port 52 to the outside of the light source unit 50.

Meanwhile, the air flowing inside the horizontal duct 66 is also used for cooling the light source unit 50 from the outside. A part of the air flowing inside the horizontal duct 66 is guided to the outer regions of the light source unit 50 through a light-source periphery introducing duct 67 and cools the light source unit 50 from the outside. The air then passes through a light-source periphery discharging duct 68 and joins with the air exhausted through the light-source air exhaust port 52 to the outside of the light source unit 50.

The air after cooling the light source unit 50 is guided toward an exhaust fan 70 along with a flow passage guide 69. The exhaust fan 70 sucks the air inside the projector 100 to exhaust the air through an exhaust port 71.

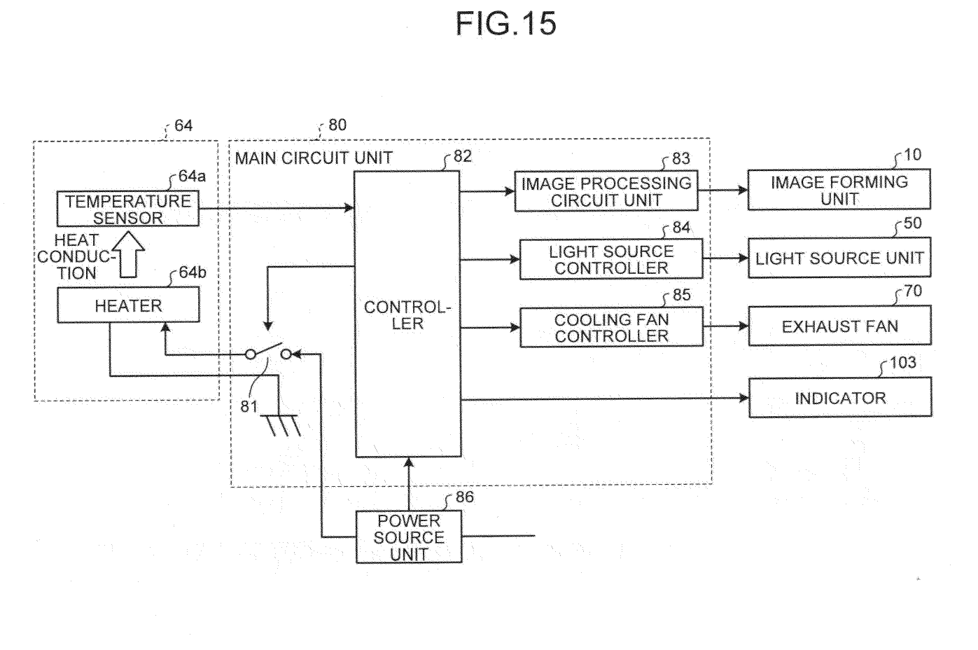

The flow passage through which the air moves in a straight line in the projector 100 is a flow passage for cooling power source circuits (a power source unit 86 illustrated in FIG. 15, for example) and electronic substrates (a main circuit unit 80 illustrated in FIG. 15, for example) in the housing of the projector 100. The flow passage guide 69 also functions to prevent the air heated due to the air-cooling of the light source unit 50 from heating other equipment inside the projector 100, such as the electronic substrates.

Temperature Detecting Device

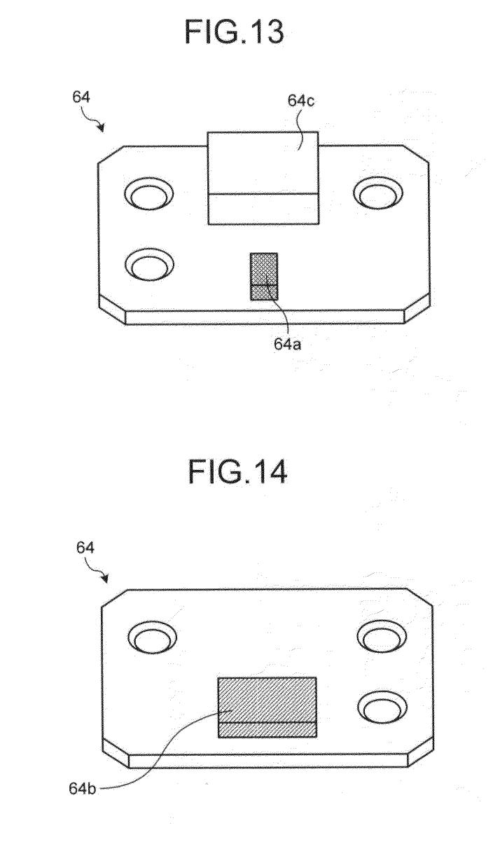

The following describes the configuration example of the temperature detecting device 64 with reference to FIGS. 13 and 14. FIG. 13 is a perspective view illustrating the configuration of the front surface of the temperature detecting device 64, and FIG. 14 is a perspective view illustrating the configuration of the back surface of the temperature detecting device 64.

As illustrated in FIGS. 13 and 14, the temperature detecting device 64 includes a temperature sensor 64a at the front surface of a single substrate of the detecting device 64 and a heater 64b at the back surface of the single substrate. The heater 64b contains therein a heat-producing member to be heated by electric power supplied through a connector 64c. Heat generated by the heater 64b conducts to the temperature sensor 64a through the substrate. The temperature sensor 64a measures the heat generated by the heater 64b through heat conduction.

The temperature sensor 64a may be provided next to the heater 64b so as to measure the heat generated by the heater 64b through heat conduction. A proper heat conducting substance is provided between the temperature sensor 64a and the heater 64b, and the embodiment of the present invention can be properly performed so long as they are configured to cool the heat conducting substance with air.

As described above, the temperature detecting device 64 is arranged near the air-intake port 102 in the projector 100 and is cooled by air taken from the outside of the projector 100 through the air-intake port 102. The value measured by the temperature sensor 64a is kept low in a state where the temperature detecting device 64 is properly cooled because the temperature sensor 64a measures heat that has undergone heat conduction. In contrast, the value measured by the temperature sensor 64a is abnormal in a state where the temperature detecting device 64 is not properly cooled because of clogging up of the air-intake port 102, for example.

FIG. 15 is a block diagram of the main circuit unit 80 that performs a protection operation for the projector 100. As illustrated in FIG. 15, the main circuit unit 80 performs the protection operation for the projector 100 by monitoring a decrease in the flow velocity of outside air taken in through the air-intake port 102 based on the output from the temperature detecting device 64.

Electric power is supplied from the power source unit 86 to the heater 64b of the temperature detecting device 64 via a switch 81 that is opened and closed under the control of a controller 82 of the main circuit unit 80. Namely, the main circuit unit 80 can acquire both a temperature value measured by the temperature sensor 64a when the heater 64b is generating heat and a temperature value measured by the temperature sensor 64a when the heater 64b is not generating heat.

The temperature value measured by the temperature sensor 64a when the heater 64b is not generating heat is the same as the value obtained by measuring the temperature outside the projector 100 regardless of clogging up of filter has occurred or not. On the other hand, the temperature value measured by the temperature sensor 64a when the heater 64b is generating heat varies depending on the flow velocity of outside air taken in through the air-intake port 102. When the flow velocity of outside air taken in decreases due to filter clogging or other reasons, the air fails to cool the heat generated by the heater 64b, leading to an increase in the proportion of heat conduction to the temperature sensor 64a. This results in an increase in the temperature value measured by the temperature sensor 64a.

The temperature value measured by the temperature sensor 64a when the heater 64b is not generating heat is equal to the temperature outside the projector 100 and thus can be employed as a reference temperature. In other words, the temperature value measured by the temperature sensor 64a when the heater 64b is generating heat is acquired while the temperature value measured by the temperature sensor 64a when the heater 64b is not generating heat is employed as a reference value. The difference between the two measured temperature values indicates a decrease in the flow velocity of outside air taken in, due to clogging up of filter or other reasons.

Using the aforementioned property, the controller 82 of the main circuit unit 80 monitors a decrease in ability to take in outside air, due to clogging up of filter or other reasons. More precisely, first, the controller 82 of the main circuit unit 80 adjusts the switch 81 to supply electric power to the heater 64b and acquires the temperature value measured by the temperature sensor 64a in this state. This measured temperature value is determined as a first temperature measurement value. The controller 82 of the main circuit unit 80 then adjusts the switch 81 to supply no electric power to the heater 64b and acquires the temperature value measured by the temperature sensor 64a in this state. This measured temperature value is determined as a second temperature measurement value. The difference between the first temperature measurement value and the second temperature measurement value indicates a decrease in the flow velocity of outside air taken in. Thus, the controller 82 of the main circuit unit 80 performs the protection operation for the projector 100 when the difference between the first temperature measurement value and the second temperature measurement value reaches equal to or larger than a given value.

For example, as the protection operation for the projector 100, the image displaying function of the projector 100 displays occurrence of a disadvantageous condition in the air-intake port 102. Specifically, the controller 82 controls the image forming unit 10 via an image processing circuit unit 83 so that the projection image contains indication of the occurrence of the disadvantageous condition.

For example, also as the protection operation for the projector 100, the amount of light emitted from the light source is reduced. Specifically, the controller 82 reduces the amount of electric power supplied to the light source of the light source unit 50 via a light source controller 84.

For example, also as the protection operation for the projector 100, the rotating speed of a cooling fan is increased. This cooling fan is, for example, the exhaust fan 70. Specifically, the controller 82 increases the amount of electric power supplied to the exhaust fan 70 via a cooling fan controller 85.

For example, also as the protection operation for the projector 100, an indicator 103 of the projector 100 lights up or flashes. The indicator 103 is provided at the top cover of the projector 100 (see FIG. 1), and the controller 82 causes the indicator 103 to light up or flash for alarm indication.

As described above, in the embodiment of the present invention, the value measured by the temperature sensor 64a when the heater 64b is not generating heat is employed as a reference value, and thus, this eliminates the necessity to measure the temperature outside the projector 100. Therefore, a decrease in ability to take in outside air, due to clogging up of filter or other reasons, can be monitored by using temperature values measured by this single temperature sensor 64a.

An embodiment of the present invention allows monitoring of a decrease in ability to take in outside air by measuring a temperature at a single measurement point.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image projection apparatus comprising:
an air-intake port that is provided at a housing and is configured to take in outside air for cooling inside of the housing;
a heat generating unit that is provided near the air-intake port and generates heat with supply of electric power;
a temperature detecting unit that is provided next to the heat generating unit; and
a controlling unit that monitors a decrease in a flow velocity of outside air taken in through the air-intake port based on a temperature value measured by the temperature detecting unit.

2. The image projection apparatus according to claim 1, wherein
the controlling unit
by controlling an electric power supplied to the heat generating unit, acquires, as a first temperature measurement value, a temperature value measured by the temperature detecting unit when the heat generating unit is generating heat, and as a second temperature measurement value, a temperature value measured by the temperature detecting unit when the heat generating unit is not generating heat, and
monitors decrease in the flow velocity of the outside air taken in through the air-intake port based on a difference between the first temperature measurement value and the second temperature measurement value.

3. The image projection apparatus according to claim 2, wherein
the controlling unit performs a protection operation for the image projection apparatus when the difference between the first temperature measurement value and the second temperature measurement value reaches equal to or larger than a given value.

4. The image projection apparatus according to claim 3, wherein
the protection operation is an operation to indicate occurrence of a disadvantageous condition in the air-intake port using an image displaying function of the image projection apparatus.

5. The image projection apparatus according to claim 3, wherein
the protection operation is an operation to reduce an amount of light emitted from a light source included in the image projection apparatus.

6. The image projection apparatus according to claim 3, wherein
the protection operation is an operation to increase rotating speed of a cooling fan included in the image projection apparatus.

7. The image projection apparatus according to claim 3, wherein
the protection operation is an operation to cause an indicator included in the image projection apparatus to light up or flash.

8. A method for controlling an image projection apparatus that includes an air-intake port that is provided at a housing and is configured to take in outside air for cooling inside of the housing, a heat generating unit that is provided near the air-intake port and generates heat with supply of electric power, and a temperature detecting unit that is provided next to the heat generating unit, the method comprising:
monitoring a decrease in a flow velocity of outside air taken in through the air-intake port based on a temperature value measured by the temperature detecting unit.
